(19) United States
(12) Patent Application Publication
(10) Pub. No.: US 2023/0278067 A1
(43) Pub. Date: Sep. 7, 2023

(54) DISPENSER

(71) Applicant: medmix Switzerland AG, Haag (CH)

(72) Inventors: Hayden TURNER, Ayer, MA (US); Garrett FAINO, Manchester, NH (US)

(21) Appl. No.: 17/926,515

(22) PCT Filed: May 27, 2021
(86) PCT No.: PCT/EP2021/064158

§ 371 Date: Nov. 18, 2022

Related U.S. Application Data
Application No. PCT/EP2021/064158 is a continuation of application No. 16/891,166, filed on Jun. 3, 2020, now abandoned.

(51) Int. Cl. B05C 17/01; B05C 17/005

(52) U.S. Cl. CPC B05C 17/0116; B05C 17/00553; B05C 17/00576; B05C 17/00596; B05C 17/0136

(57) ABSTRACT

A dispenser includes a housing, a push rod, and a push rod driving mechanism. The push rod is moveable relative to the housing. The housing has at least two housing parts and is configured to receive at least a portion of the push rod driving mechanism to move the push rod relative to the housing. The at least two housing parts are held together by the push rod.

### CROSS-REFERENCE TO RELATED APPLICATION

This application is a U.S. National Stage application of International Application No. PCT/EP2021/064158, filed May 27, 2022, which claims priority to U.S. Application No. 16/891,166, filed Jun. 3, 2020, the contents of each of which are hereby incorporated by reference.

### TECHNICAL FIELD

The present disclosure generally relates to a dispenser. More specifically, the present disclosure relates to a dispenser having a two-part housing where the two parts of the housing are held together by a push rod movable to force a material to be dispensed. Background Information

Material dispensers are known for dispensing one-component and two-component materials, such as adhesives, sealants, paints, bonding agents, building materials etc. On assembling such dispensers, a dispenser driving mechanism and its associated parts are installed within a housing. For this purpose, the parts are mounted in the housing and the housing is then fastened together. The design and functions of material dispensers are regularly being improved. In this connection the housing and the mounting of the parts within the housing are typically comparatively complex and the assembly of the dispenser is demanding in effort and cost.

### SUMMARY

One object of the present disclosure is therefore to provide a dispenser that is simpler to assemble with less effort and cost in comparison to prior art dispensers. A further object of the present disclosure is to provide a housing that is more cost effective in its manufacture.

This object is satisfied by a dispenser having the features disclosed herein. In particular, in that the housing comprises two parts that are held together by a push rod and indeed without extra screws that extend through the housing and that is movable relative to the housing. In this way the number of components forming the housing are reduced leading to a reduction in complexity of the housing and a reduced number of parts, so that the dispenser can be assembled faster and at a reduced cost.

One further advantage of the present disclosure is that a dispenser housing with two parts that is assembled without the use of tools is provided.

It has been discovered that an improved housing for a dispenser is desired. In view of the state of the known technology, one aspect of the present disclosure is to provide with dispenser with a housing, a push rod and a push rod driving mechanism. The push rod is moveable relative to the housing. The housing has at least two housing parts and is configured to receive at least a portion of the push rod driving mechanism for moving the push rod relative to the housing. The at least two housing parts are held together by the push rod.

Through use of such a dispenser, the structure of the housing is simplified. Further, assembly of the housing is also simplified.

In a second aspect of the present disclosure, which can be used in connection with the first aspect, the at least two housing parts are further held together by a screw-less connection structure. The screw-less connection structure further simplifies the structure of the housing. Moreover, the assembly time for assembly of the housing is reduced because no tools are required for tightening the screws for assembly

In a third aspect of the present disclosure, which can be used in connection with the first aspect, each of the at least two housing parts includes at least one corresponding ring, with the portion of the push rod being guided through each one of the corresponding ring to hold the at least two housing parts together. The portion of the push rod is inserted into each of the corresponding rings without the use of tools.

In a fourth aspect of the present disclosure, which can be used in connection with the third aspect, each of the at least two housing parts includes recesses formed therein, each of the at least one corresponding ring extends into a corresponding one of the recesses, i.e. a part of each ring is accommodated in each recess in a shape matching manner. An advantage of the inclusion of the recesses is that each of the rings is received in a corresponding one of the recesses thereby aligning the two housing parts with one another.

Another object of the present disclosure is to provide a dispenser housing with two parts held together by a screw-less connection structure. An advantage of this structure is that the two parts of the housing are assembled without the use of tools.

The above objects are also satisfied by a dispenser having the features defined in claim 5. In view of the state of the known technology, a fifth aspect of the present disclosure is to provide a dispenser with a housing, a push rod and a push rod driving mechanism. The push rod is moveable relative to the housing via the push rod driving mechanism. The housing comprises at least two housing parts and indeed preferably only two housing parts and is configured to receive at least a portion of the push rod driving mechanism for moving the push rod relative to the housing. The two of the at least two housing parts are held together by a screw-less connection structure.

The screw-less connection structure simplifies the structure of the housing, since no provision has to be made within the housing for placing and attaching screws within one or more of the housing parts, which reduces the complexity of the housing and its weight. Moreover, the assembly time of the housing is reduced because no tools are required for assembly.

In a sixth aspect of the present disclosure which can be used in combination with the fifth aspect, the dispenser includes that the two of the at least two housing parts are further held together by the portion of the push rod. This is due to the fact that the push rod is guided through the two rings of each housing part, thereby fixing the two housing parts one to another and at the same time serves for aligning the two housing parts with respect to one another.

The portion of the push rod further holding the at least two housing parts together further simplifies the structure of the housing. Moreover, the assembly time of the housing is reduced because no tools are required for assembly.

In a seventh aspect of the present disclosure which can be used in combination with the fifth aspect, each of the two of the at least two housing parts includes at least one ring, with the portion of the push rod being guided through each corresponding ones of the at least one rings to hold the at least two housing parts together. Increasing the number of rings ensures the alignment of the parts relative to one another, but at the same time also increases the complexity of the housing.

The rings and push rod simplify the structure of the housing. Moreover, the rings and push rod provide a reliable mechanical connection between the at least two housing parts.

In an eighth aspect of the present disclosure which can be used in combination with the fifth aspect, the screw-less connection structure includes at least one of the following: clips, snap-fit connections, snap-in connections. Such connecting structures are comparatively simple to engage and disengage and further simplify the assembly of the housing while also providing a further point of connection between the two housing parts, with the further point of connection preferably being arranged at a part of the housing that is remote from the push rod. The at least one of the clips, snap-fit connections and snap-in connections eliminate the need for tools during the assembly process.

In a ninth aspect of the present disclosure which can be used in combination with the fifth aspect, the screw-less connection structures are located at a first portion of the housing and the push rod is moveably received in a second portion of the housing spaced apart from the first portion. The inclusion of the screw-less connection structures in the first portion and the push rod in the second portion of the housing provides reliable attachment between the first and second portions of the housing and also increases the rigidity of the completed housing.

In a tenth aspect of the present disclosure which can be used in combination with the fifth aspect, one of the at least two housing parts includes rings projecting therefrom. The rings provide attachment locations for the push rod. The rings further provide alignment locations between the at least two housing parts and on assembly of the housing are aligned via the push rod inserted into the respective rings.

In an eleventh aspect of the present disclosure which can be used in combination with the tenth aspect, another of the at least two housing parts includes recesses formed therein. The recesses provide alignment locations between the at least two housing parts.

In a twelfth aspect of the present disclosure which can be used in combination with the eleventh aspect, the rings and recesses mate to one another, i.e. are formed complementary to one another such that a ring can be received in a recess. The rings provide attachment locations with the push rod. The rings and recesses further provide alignment locations between the at least two housing parts.

In a thirteenth aspect of the present disclosure which can be used in combination with the fifth aspect, a plunger is connectable to one end of the push rod. The connectability of the plunger to the pushrod provides simplicity to the assembly of the dispenser. The plunger provides a surface to push against a plunger piston of a cartridge filled with material in order to dispense the material out of the cartridge.

In a fourteenth aspect of the present disclosure which can be used in combination with the thirteenth aspect, the plunger is clipped in place to the one end of the push rod. The clip of the plunger and attachment to the pushrod provides simplicity to the assembly of the dispenser.

In a fifteenth aspect of the present disclosure which can be used in combination with the fifth aspect, a handle can be pivoted relative to the push rod in order to transfer a force from the handle on to the push rod. The handle provides a simple way to bring about dispensing of material from a material filled cartridge.

In a sixteenth aspect of the present disclosure which can be used in combination with the fifth aspect, a rack is configured to receive a cartridge, the rack being rotatable relative to the housing. The rack retains a removable cartridge for ease and convenience of usage of the dispenser. The rack is rotatable relative to the housing in order retain the cartridge within the rack providing a more reliable retention of the cartridge. On placement of the rack at the housing this may be slid into place and then rotated relative to the housing to provide a further point of connection for fastening the two housing parts one to another.

Still another object of the present disclosure is to provide a dispenser housing with a simple and rapid assembly process. An advantage of this object is that an end user can easily and quickly assemble the dispenser without the use of tools.

The above objects are also satisfied by a dispenser being assembled using the method disclosed herein. In view of the state of the known technology, a seventeenth aspect of the present disclosure is to provide a method of assembling a dispenser, the dispenser comprising a housing, a push rod, and a push rod driving mechanism, with the push rod being moveable relative to the housing, the housing having at least two housing parts and being configured to receive at least a portion of the push rod driving mechanism for moving the push rod relative to the housing. The method comprises: connecting the at least two or more housing parts; and inserting the push rod into the housing to hold together the at least two housing parts.

An advantage to this arrangement is that the housing parts can be easily and quickly assembled.

In an eighteenth aspect of the present disclosure which can be used in combination with the seventeenth aspect, the method further comprises attaching a plunger to one end of the push rod after inserting the push rod into the housing.

The arrangement of the plunger being attached to the push rod provides a simple and quick way to continue the assembly process.

In a nineteenth aspect of the present disclosure which can be used in combination with the seventeenth aspect, the inserting the push rod into the housing includes removing a temporary rod from the housing. The temporary rod can be installed to one of the two housing parts to temporarily retain mechanisms within the housing and temporarily hold the two housing parts together.

In a twentieth aspect of the present disclosure which can be used in combination with the nineteenth aspect, the method further includes attaching a rack to the housing, for example, by sliding the rack onto a part of the housing and then rotating the rack relative to the housing. The attachment of the rack further provides simplicity to the overall assembly method of the dispenser.

### BRIEF DESCRIPTION OF THE DRAWINGS

Embodiments of the disclosure will be explained in more detail hereinafter with reference to the drawings.

FIG. 1 is a perspective view of a dispenser showing a housing, a push rod, a push rod driving mechanism and a rack in accordance with an exemplary embodiment;

FIG. 2 is an exploded perspective view showing a first part and a second part of the housing and elements of the push rod driving mechanism in accordance with an exemplary embodiment;

FIG. 3 is a perspective view of an upper section of the first part of the housing with the second part removed showing elements of the push rod driving mechanism and rings in accordance with the exemplary embodiment;

FIG. 4 is a side view of the upper section of the first part of the housing showing some of the elements of the push rod driving mechanism, rings and recesses in accordance with the exemplary embodiment;

FIG. 5 is a perspective view of an upper section of the second part of the housing with the first part removed showing rings and recesses of the second part in accordance with the exemplary embodiment;

FIG. 6 is a side view of the upper section of the second part of the housing showing the rings and the recesses of the second part in accordance with the exemplary embodiment;

FIG. 7 is a top exploded view of the upper sections of each of the first part and the second part of the housing showing a temporary rod along with rings of the first part and the second part in solid lines and recesses of the first part and second part shown in phantom in accordance with the exemplary embodiment;

FIG. 8 is a top view of the upper sections of the first part and the second part of the housing joined together showing the temporary rod being installed into the rings of the first part and the rings of the second part in accordance with the exemplary embodiment;

FIG. 9 is another top view of the upper sections of the first part and the second part of the housing joined together showing the temporary rod fully installed into the rings of the first part and the rings of the second part in accordance with the exemplary embodiment;

FIG. 10 is a perspective view of the upper sections of the first part and the second part of the housing joined together showing the second part in solid lines and the first part of the housing in phantom in accordance with the exemplary embodiment;

FIG. 11 is a perspective exploded view of the lower sections of each of the first part and the second part of the housing showing screw-less connection structures that fix the lower sections of the first part and the second part together in accordance with the exemplary embodiment;

FIG. 12 is another perspective view of the housing partially assembled showing the push rod being inserted into the housing and pushing the temporary rod out of the housing in accordance with the exemplary embodiment;

FIG. 13 is a perspective exploded view of the push rod and the plunger in accordance with the exemplary embodiment;

FIG. 14 is a side cross-sectional view of the push rod and plunger attached to one another in accordance with the exemplary embodiment; and

FIG. 15 is another side cross-sectional view of the push rod installed to the plunger with the push rod pulled rearward with a portion of the plunger being confined within a recess of a forward end of the housing preventing removal of the push rod from the plunger in accordance with the exemplary embodiment.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the disclosure as defined by the appended claims and their equivalents.

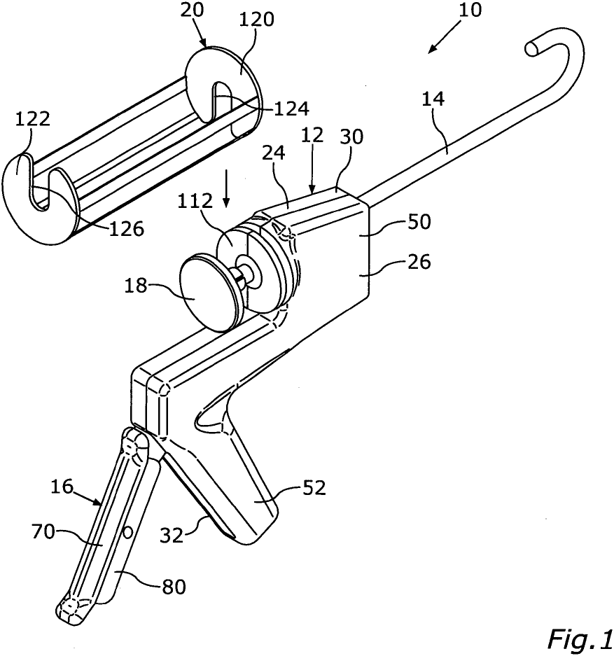

Referring initially to FIG. 1, a dispenser 10 is illustrated in accordance with a first embodiment. As shown in FIG. 1, the dispenser 10 basically includes a housing 12, a push rod 14, a push rod driving mechanism 16, a plunger 18 and a rack 20.

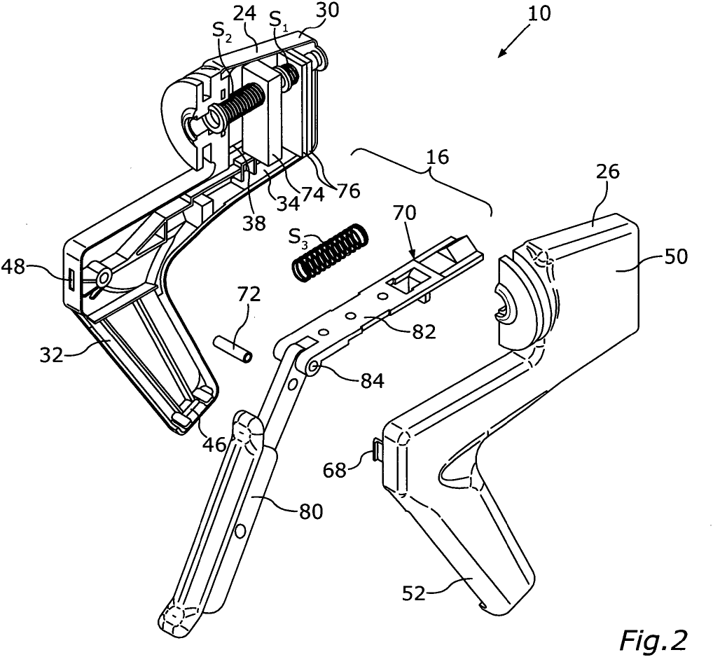

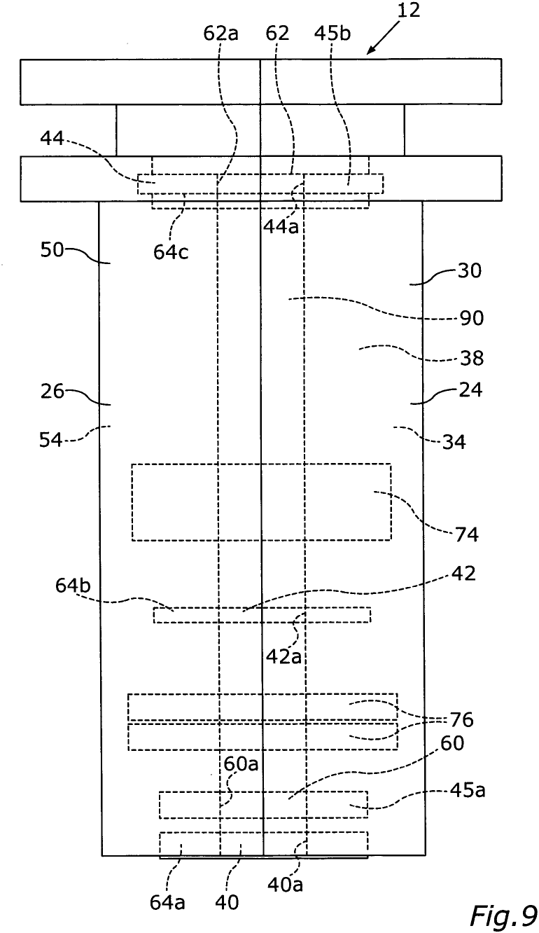

As shown in FIGS. 2-11, the housing 12 has at least two housing parts including a first part 24 and a second part 26. As shown in FIGS. 2-4 and 7-11, the first part 24 has an upper section 30 and a lower section 32 that are preferably formed together as a single unitary monolithic element. The upper section 30 defines a concaved area 34 that at least partially defines a hollow interior 38 of the housing 12 when the first part 24 and the second part 26 are fitted and fixed together. The concaved area 34 of the upper section 30 further defines spaces that receive elements of the push rod driving mechanism 16, such as the first and second rod members 74 and 76. As shown in FIGS. 4, 7 and 9, the upper section 30 further includes a first ring 40, a second ring 42 and a third ring 44. The first ring 40, the second ring 42 and the third ring 44 serve at least two purposes. First, each of the first ring 40, the second ring 42 and the third ring 44 is formed with respective co-axially aligned bores 40a, 40b and 40c, as shown in FIG. 9.

In this connection it should be noted that the upper section 30 houses the push rod 14, whereas the lower section 32 comprises the handle of the dispenser 10.

Preferably, the first, second and third rings 40, 42 and 44 are formed as a part of the first part 24 of the housing 12. For example, the first part 24 can be injection molded simultaneously with the rings 40, 42 and 44 where the rings 40, 42 and 44 are made of from the same injected material as the remainder of the first part 24. In an alternative embodiment, the rings 40, 42 and 44 can be made of a different material, such as a hardened rigid polymer or plastic material, or a metallic material, with the first part 24 being molded around portions of the rings 40, 42 and 44.

It should be understood from the drawings and the description herein that the upper section 30 of the first part 24 of the housing 12 can include any number of rings such as the first, second and third rings 40, 42 and 44, depending upon the overall design and dimensions of the dispenser 10. More specifically, in some designs only two rings can be employed, and, other designs or embodiments can include 4, 5, 6 or more rings.

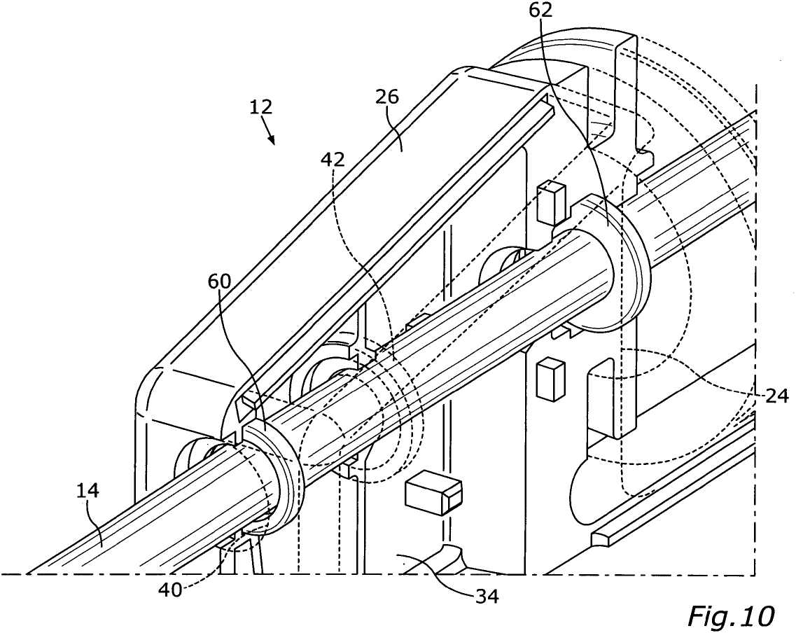

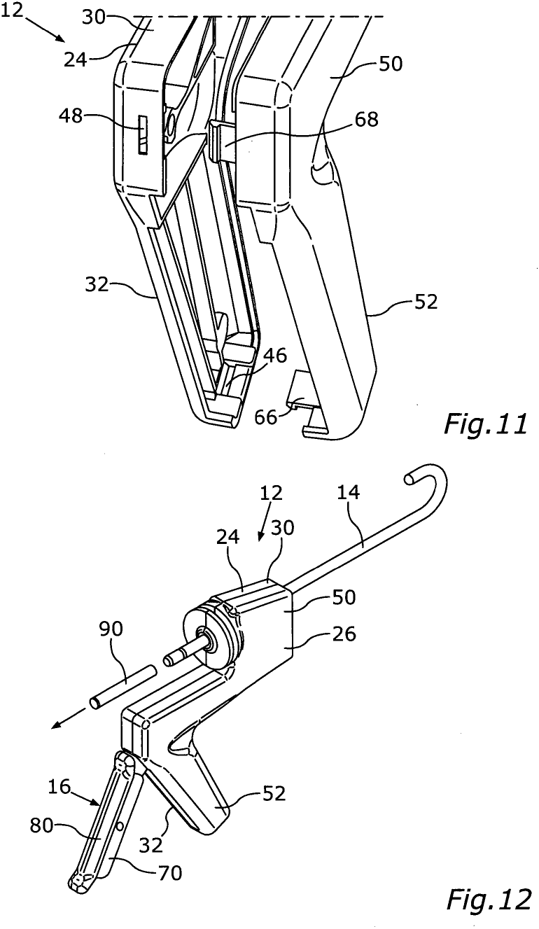

As shown in FIGS. 2 and 11, the lower section 32. of the first part 24 of the housing 12 includes at least a lower slot 46 and an upper slot 48 whose function and purpose are described further herein below.

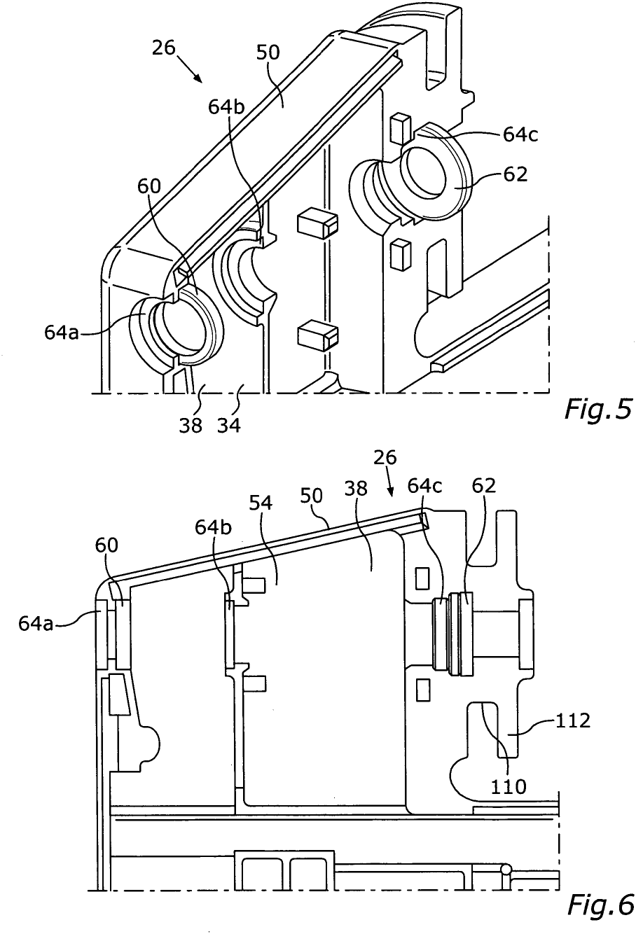

As shown in FIGS. 5-10, the second part 26 has an upper section 50 and a lower section 52 that are preferably formed together as a single unitary monolithic element and complementary to the first part 24. The upper section 50 defines a concaved area 54 that defines the hollow interior 38 of the housing 12 along with the concaved area 34 of the first part 24 when the first part 24 and the second part 26 are fitted and fixed together. The concaved area 54 of the upper section 50 further defines spaces that receive elements of the push rod driving mechanism 16. The upper section 50 further includes a first ring 60 and a second ring 62. The first ring 60 and the second ring 62 serve at least two purposes. First, each of the first ring 60 and the second ring 62 is formed with respective co-axially aligned bores 60a and 60b, as shown in FIG. 9.

Preferably, the first and second rings 60 and 62 are formed as an integral part of the second part 26 of the housing 12. For example, the second part 26 can be injection molded simultaneously with the rings 60 and 62 where the rings 60 and 62 are made of from the same injected material as the remainder of the second part 26. In an alternative embodiment, the rings 60 and 62 can be made of a different material, such as a hardened rigid polymer or plastic material, or a metallic material, with the second part 26 being molded around portions of the rings 60 and 62.

It should be understood from the drawings and the description herein that the upper section 30 of the second part 26 of the housing 12 can include any number of rings such as the first, second and third rings 60 and 62, depending upon the overall design and dimensions of the dispenser 10. More specifically, in some designs only two rings can be employed, and, other designs or embodiments can include 3, 4, 5, 6 or more rings.

As shown in FIGS. 2 and 11, the lower section 52 of the second part 26 of the housing 12 includes at least a lower snap-fitting projection 66 (FIG. 11 only) and an upper snap-fitting projection 68 (FIGS. 2 and 11). The lower snap-fitting projection 66 is positioned and dimensioned to deflect during assembly of the housing 12 and fit into the lower slot 46. The upper snap-fitting projection 68 is similarly positioned and dimensioned to deflect during assembly of the housing 12 and fit into the upper slot 48. Engagement between the lower snap-fitting projection 66 and the lower slot 46, and the engagement between the upper snap-fitting projection 68 and the upper slot 48 locks the lower section 32 of the first part 24 to the lower section 52 of the second part 26 of the housing 12. The engagement between the lower snap-fitting projection 66 and the lower slot 46, and the engagement between the upper snap-fitting projection 68 and the upper slot 48 is also referred to as a screw-less connection structure.

The screw-less connection structures can include at least one of the following: clips, snap-fit connections, snap-in connections, or combinations thereof, and is not limited to the snap-fitting projections and slots described herein. Alternatively, the screw-less connection structures can include pins with cotter pins, split pins, cotter key or snap-fitting pins.

As shown in FIGS. 2-4, the push rod driving mechanism 16 includes a handle lever assembly 70, a pivot pin 72, a first rod member 74, second rod members 76, and biasing members S₁, S₂ and S₃. In the depicted embodiment the biasing members S₁, S₂ and S₃ are coil springs. However, it should be understood from the drawings and the description herein that the biasing members S₁, S₂ and S₃ can alternatively be replaced with other biasing elements, such as leaf spring elements, compressible polymer elements or other biasing materials or structures.

As shown in FIG. 4, the biasing member S₁ is disposed within the first part 24 of the housing 12 between the second ring 42 and the second rod members 76. The biasing member S₂ is disposed within the first part 24 of the housing 12 between the third ring 44 and the first rod member 74.

As shown in FIG. 2, the handle lever assembly 70 includes a handle 80 that is pivotally attached to a slider 82 via a hinge 84. The biasing member S₃ is disposed within the first part 24 of the housing 12 between a projection within the first part 12 and a tab that extends downward from the slider 82. The handle 80 is installed within the housing 12 via the pivot pin 72. During operation of the dispenser 10, when a user pulls back on the handle 80, the handle 80 pivots about the pivot pin 72. The hinge 84 and the pivot pin 72 are spaced apart from one another. Hence, handle 80 acts as a lever pulling the slider 82 forward. The slider 82 has an openings that receive lower ends of the first rod member 74 and the second rod member 76 causing the push rod 14 to move forward. Since operation of the push rod mechanism 16 is well known in the art, further description is omitted for the sake of brevity.

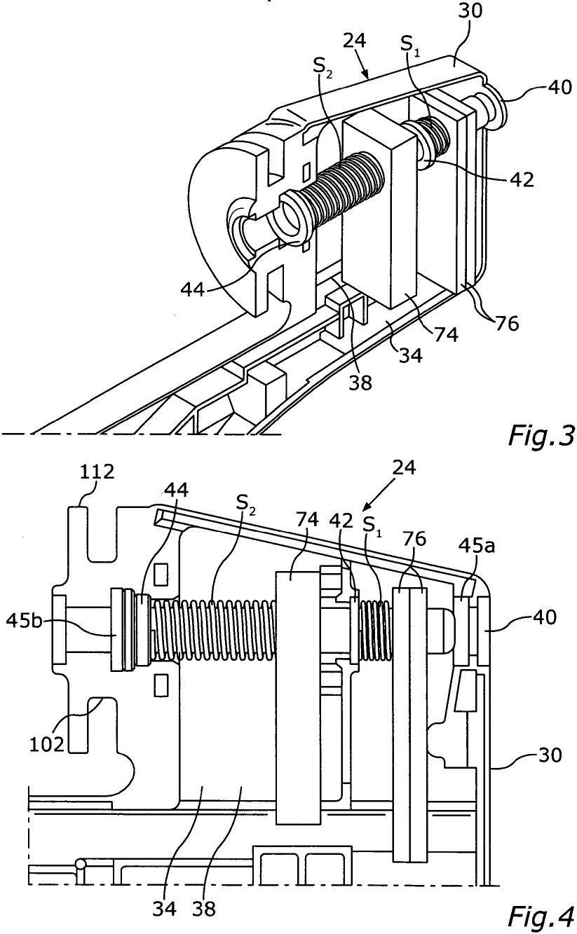

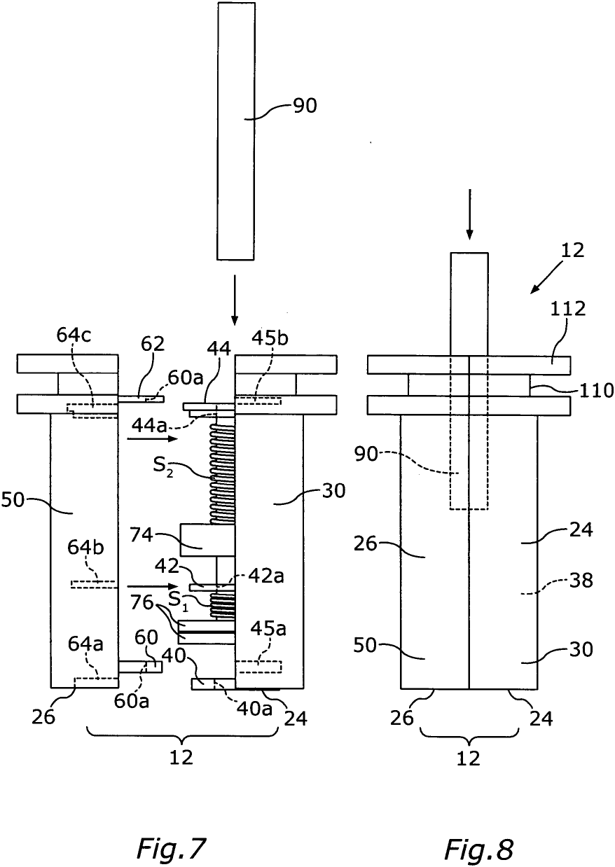

As shown in FIGS. 7-9, during early stages of assembly of the housing 12, the push rod driving mechanism 16 is installed to the first part 24 of the housing 12. Next, the first part 24 and the second part 26 of the housing 12 fitted together, as shown in FIGS. 7 and 8. In the state shown in FIG. 8, the first ring 40 is received in a semi-circular recess 64a (see FIGS. 6 and 7) formed in the second part 26. The second ring 42 is received in a semi-circular recess 64b (see FIGS. 6 and 7) formed in the second part 26. Similarly, the third ring 44 is received in a semi-circular recess 64c (see FIGS. 6 and 7) formed in the second part 26. Similarly, the first ring 60 of the second part 26 is received in a semi-circular recess 45a formed in the first part 24 (see FIGS. 3 and 7) and the second ring 62 is received in a semi-circular recess 45b (see FIGS. 3 and 7) formed in the first part 24.

Also, in the state shown in FIG. 8, the bores 40a, 42a, 44a, 60a and 62a are aligned with one another along with openings in the first rod member 74 and second rod members 76 and the springs S₁ and S₂. A temporary rod 90 is then pushed into and through each of the bores 40a, 42a, 44a, 60a and 62a, through the openings in the first rod member 74 and second rod members 76 and the springs S₁ and S₂. Since the temporary rod extends through the bores 40a, 42a, 44a, 60a. and 62a in the rings 40, 42, 44, 60 and 62, the first part 24 and the second part 26 are held together by the temporary rod 90.

When the first part 24 and the second part 26 are fitted together, the lower snap-fitting projection 66 deflects slightly and snap-fits into the lower slot 46. Simultaneously, the upper snap-fitting projection 46 deflects slightly and snap-fits into the upper slot 48, as indicated in FIG. 11. Hence, the housing is easily assembled.

Consequently, the housing 12 can be assembled and packaged with the remainder of the dispenser 10 (the push rod 14, the plunger 18 and rack 20) to be latter installed by, for example, an end user. Afterwards, as shown in FIG. 12, the push rod 14 can be pushed through the bores 40a, 42a, 44a, 60a and 62a, thereby pushing the temporary rod 90 out of the housing 12.

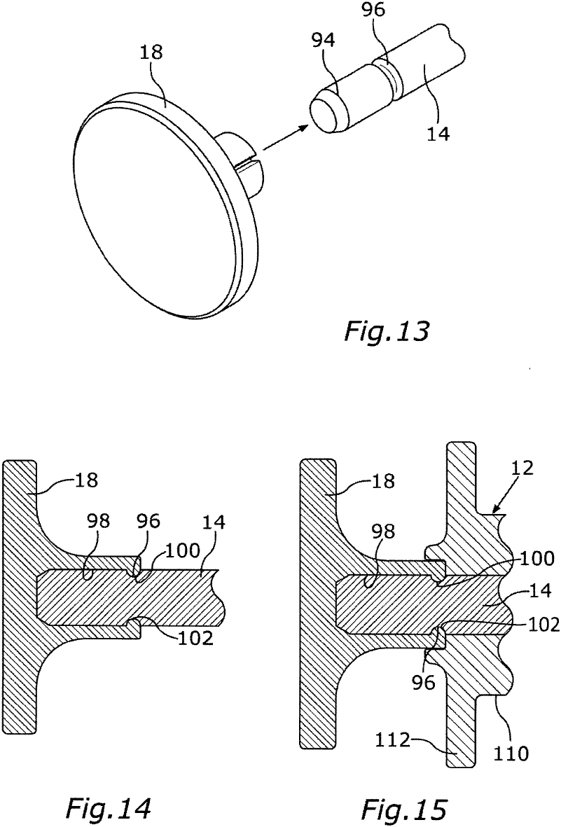

Final assembly can occur anytime thereafter and includes installing the plunger 18 to a distal end 94 of the push rod 14, as shown in FIGS. 13 and 14. As is also shown in FIGS. 13 and 14, the distal end 94 of the push rod 14 includes an annular recess 96. As shown in FIGS. 14 and 15, the plunger 18 includes a bore 98 and one or more protrusions 100. The protrusions 100 can be in the form of one annular protrusion 100 within the bore 98, or, can be several spaced apart protrusions 100 that fit into the annular recess 96 fixing the plunger 18 to the push rod 14.

As shown in FIG. 15, the forward end of the housing 12 includes a recess 102 that receives the plunger 18 with the push rod 14 pulled rearward. With the end of the plunger 18 located within the recess 102, the protrusion(s) 100 are prevented from moving out of the recess 96, thereby keeping the plunger 18 attached to the push rod 14.

The forward end of the housing 12, as shown in FIGS. 1, 4, 8, 12 and 15, includes a cylindrically shaped protrusion 110 and a disc shaped end 112.

As shown in FIG. 1, the rack 20 has opposing disc shaped ends 120 and 122, each having a corresponding recess 124 and 126 defined therein. the width of the recess 124 is approximately equal to the diameter of the cylindrically shaped protrusion 110. Therefore, the rack 20 installs to the housing 12 by pushing the disc shaped end 120 on to the cylindrically shaped protrusion 110. The rack 20 can be rotated about the cylindrically shaped protrusion 110, and correspondingly about an axis (not shown) defined by the push rod 14. The rack 20 is further configured to receive a cylindrically shaped cartridge (not shown) filed with a material to be dispensed by the dispenser 10. The cylindrically shaped cartridge (not shown) has a dispensing end or nozzle (not shown) that fits into the recess 126 in the disc shaped end 122 for dispensing the material within the cartridge. Further, the rack 20 is shaped and configures such that the rack 20 can rotate about the cylindrically shaped protrusion 110 of the housing 12. Since material filed cartridges and corresponding dispensing end or nozzle are well known in the art, further description is omitted for the sake of brevity.

Once fully assembled, the handle 80 of the push rod driving mechanism 16 is pulled by a user thereby causing the push rod 14 to be moved out of the forward end of the housing 12. Movement of the push rod 14 causes movement of the plunger 18 into the cartridge forcing the material therein to be dispensed.

Simultaneously, the first part 24 and the second part 26 of the housing 12 are held together by the push rod 14.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment, the following directional terms “forward”, “rearward”, “above”, “downward”, “vertical”, “horizontal”, “below” and “transverse” as well as any other similar directional terms refer to those directions of a dispenser. Accordingly, these terms, as utilized to describe the present disclosure should be interpreted relative to the dispenser.

The term “configured” as used herein to describe a component, section or part of a device includes mechanical elements that is constructed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present disclosure, it will be apparent to those skilled in the art from this disclosure that various changes and modifications can be made herein without departing from the scope of the disclosure as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further disclosures by the applicant, including the structural and/or functional concepts embodied by such features. Thus, the foregoing descriptions of the embodiments according to the present disclosure are provided for illustration only, and not for the purpose of limiting the disclosure as defined by the appended claims and their equivalents.

1. A dispenser comprising:
a housing;
a push rod; and
a push rod driving mechanism, the push rod being moveable relative to the housing, the housing having at least two housing parts and configured to receive at least a portion of the push rod driving mechanism to move the push rod relative to the housing, the at least two housing parts held together by the push rod.

2. The dispenser in accordance with claim 1, wherein the at least two housing parts are configured to be held together by a screw-less connection structure.

3. The dispenser in accordance with claim 1, wherein
each of the at least two housing parts includes at least one corresponding ring, with the portion of the push rod being guided through each one of the corresponding ring to hold the at least two housing parts together.

4. The dispenser in accordance with claim 3, wherein
each of the at least two housing parts includes recesses formed therein, and each of the at least one corresponding ring extends into a corresponding one of the recesses.

5. A dispenser comprising:
a housing;
a push rod; and
a push rod driving mechanism, the push rod being moveable relative to the housing, the housing comprising at least two housing parts and configured to receive at least a portion of the push rod driving mechanism to move the push rod relative to the housing, two of the at least two housing parts configured to be held together by a screw-less connection structure.

6. The dispenser in accordance with claim 5, wherein
the two of the at least two housing parts are configured to be held together by the portion of the push rod.

7. The dispenser in accordance with claim 5, wherein
each of the two of the at least two housing parts includes at least one ring, with the portion of the push rod being guided through each corresponding ones of the at least one rings to hold the at least two housing parts together.

8. The dispenser in accordance with claim 5, wherein
the screw-less connection structure includes at least one of the following: clips, snap-fit connections, snap-in connections.

9. The dispenser in accordance with claim 5, wherein
the screw-less connection structure are located at a first portion of the housing and the push rod is moveably received in a second portion of the housing spaced apart from the first portion.

10. The dispenser in accordance with claim 5, wherein
one of the at least two housing parts includes rings projecting therefrom.

11. The dispenser in accordance with claim 10, wherein another of the at least two housing parts includes recesses formed thereon.

12. The dispenser in accordance with claim 11, wherein the rings and recesses mate to one another.

13. The dispenser in accordance claim 5, further comprising
a plunger connectable to one end of the push rod.

14. The dispenser in accordance with claim 13, wherein the plunger is clipped in place to the one end of the push rod.

15. The dispenser in accordance with claim 5, wherein the push rod driving mechanism includes a handle capable of being pivoted relative to the push rod in order to transfer a force from the handle on to the push rod.

16. The dispenser in accordance with claim 5, further comprising
a rack configured to receive a cartridge, the rack being rotatable relative to the housing.

17. A method of assembling a dispenser, the dispenser comprising a housing, a push rod, and a push rod driving mechanism, with the push rod being moveable relative to the housing, the housing having at least two housing parts and being configured to receive at least a portion of the push rod driving mechanism to move the push rod relative to the housing, the method comprising:
connecting the at least two or more housing parts; and
inserting the push rod into the housing to hold together the at least two housing parts.

18. The method according to claim 17, further comprising
attaching a plunger to one end of the push rod after inserting the push rod into the housing.

19. The method according to claim 17, wherein
the inserting the push rod into the housing includes removing a temporary rod from the housing.

20. The method according to any one of claim 19, further comprising
attaching a rack to the housing.
